(19) United States
(12) Patent Application Publication
(10) Pub. No.: US 2012/0061612 A1
(43) Pub. Date: Mar. 15, 2012

(54) Electrode Active Material for Secondary Battery and Method for Producing the Same, Precursor for Same, and Secondary Battery

(75) Inventors: Makoto Yoshioka, Kyoto-Fu (JP); Masutaka Ouchi, Kyoto-Fu (JP); Takeshi Hayashi, Kyoto-Fu (JP); Kunio Nishida, Kyoto-fu (JP); Hitomi Nishida, Kyoto-Fu (JP); Takafumi Inaguchi, Kyoto-Fu (JP)

(73) Assignee: MURATA MANUFACTURING CO., LTD., Nagaokakyo-Shi (JP)

(21) Appl. No.: 13/225,603

(22) Filed: Sep. 6, 2011

(30) Foreign Application Priority Data
Sep. 10, 2010 (JP) 2010-202783

(51) Int. Cl. H01M 4/525; H01M 4/88

(52) U.S. Cl. 252/182.1

(57) ABSTRACT

A method for producing an electrode active material for a secondary battery, which contains a lithium containing phosphate compound with a olivine-type framework represented by LiMPO₄ (wherein, M is one or more elements selected from the group consisting of Mn, Fe, Co, Cu, Ni, and Mg), and in the method, a mixed powder of starting raw materials for the electrode active material for a secondary battery is subjected to firing at a first temperature, and then to grinding, and further subjected to firing at a second temperature higher than the first temperature. The first firing step includes a step of heating the mixed powder of the raw materials until a volatile component is removed almost completely.

### BACKGROUND OF THE INVENTION

1. Field of the Invention

The present invention relates to a method for producing an electrode active material for a secondary battery, an electrode active material for a secondary battery, a secondary battery including the electrode active material, and a precursor for the electrode active material for a secondary battery.

2. Description of the Related Art

As secondary batteries with high energy densities, secondary batteries have been used which are adapted to carry out charge and discharge by transfer of lithium ions between a positive electrode and a negative electrode.

In these secondary batteries, lithium-transition metal composite oxides such as a lithium cobalt oxide (LiCoO₂) have been typically used as positive electrode active materials. In recent years, inexpensive positive electrode materials in place of lithium cobalt oxide have been required from the standpoints such as cost and resources. Thus, olivine-type oxygen acid lithium compounds have been attracting attention as positive electrode materials.

For example, the International Publication WO2008/018633 (hereinafter, referred to as Patent Document 1) discloses a method for producing a compound which has an olivine structure, and suggests the use of the compound which has an olivine structure for a positive electrode active material. Specifically, Patent Document 1 discloses a method of producing a compound which has an olivine structure, in particular, olivine-type lithium manganese phosphate by mixing and firing a manganese source, a lithium source, and a phosphorus source. Patent Document 1 discloses the firing step which is carried out preferably in two steps of: a preliminary firing step typically carried out at a temperature of 200° C. to 400° C.; and a main firing step typically carried out at a temperature of 400° C. to 800° C., in order to further increase the crystallinity of the compound produced. As starting raw materials, a manganese oxide or the like; a lithium carbonate, a lithium phosphate, or the like; and a phosphoric acid, a lithium phosphate, or the like are used respectively for the manganese source, the lithium source, and the phosphorus source.

### SUMMARY OF THE INVENTION

As described in Patent Document 1, carbonates, metal oxides, phosphates, etc. are used as starting raw materials for the synthesis of a lithium containing phosphate compound which has an olivine structure (also referred to as of an olivine type). When these raw materials are used to synthesize an olivine-type lithium containing phosphate compound, large amounts of volatile compounds such as an oxygen compound, a nitrogen compound, a hydrogen compound, and a carbon compound are produced and removed in the course of synthesis.

For example, in the case of LiMnPO₄ as an olivine-type lithium containing phosphate compound, obtained in accordance with an example described in Patent Document 1, the use of a lithium carbonate, a manganese oxide (Mn₃O₄), and a diammonium hydrogenphosphate as raw materials at a stoichiometric ratio results in 64% of the total mass of the raw materials into an olivine-type lithium manganese phosphate compound, but the rest of 36% removed by volatilization in the course of synthesis.

On the other hand, methods for producing electrode active materials for secondary batteries include a grinding step of grinding electrode active material particles or precursors therefor in many cases, in order to obtain homogeneous electrode active materials. More specifically, methods for producing olivine-type lithium containing phosphate compounds as electrode active materials for secondary batteries also include a step of grinding electrode active material particles, raw materials therefor, or precursors therefor.

The inventors have found that when the raw materials as mentioned above are used to produce an olivine-type lithium containing phosphate compound as an electrode active material for secondary batteries, the production of volatile components proceeds partially in the grinding step. As a result, it has been determined that the internal pressure in the grinding vessel is increased. For this reason, in the case of producing an olivine-type lithium containing phosphate compound as an electrode active material for secondary batteries, there is a problem that the grinding vessel needs to be provided with a gas exhaust mechanism such as a leak valve.

Further, the inventors have found that in the case of adding carbon powder to a positive electrode active material for the purpose of compensation for electron conductivity as in the case of the example described in Patent Document 1, the addition of carbon powder with volatile components remaining after preliminary firing reduces the effect of compensation for electron conductivity through the reaction of the volatile components with the carbon powder during main firing.

In the case of Patent Document 1, the firing step is carried out in the two steps of the preliminary firing step and the main firing step in order to increase the crystallinity of the olivine-type lithium containing phosphate compound, in which the preliminary firing temperature is as low as 400° C. or less. For this reason, the removal of volatile components is incomplete, and the production of volatile components proceeds partially in the grinding step. As a result, the internal pressure in the grinding vessel is increased. In addition, since the volatile components remaining after the preliminary firing react with the carbon source or the carbon powder, the effect of compensation for electron conductivity is insufficient.

Therefore, an object of the present invention is to provide a method for producing an electrode active material for a secondary battery, containing an olivine-type lithium containing phosphate compound, which is capable of suppressing an increase in the internal pressure in a vessel due to volatile components produced in a grinding step.

In addition, another object of the present invention is to provide a method for producing an electrode active material for a secondary battery, containing an olivine-type lithium containing phosphate compound, which is capable of producing the effect for electron conductivity sufficiently through the addition of carbon powder to a positive electrode active material.

Furthermore, another object of the present invention is to provide a precursor for an electrode active material for a secondary battery, containing an olivine-type lithium containing phosphate compound, which causes no problems such as coarse particles produced in a step subsequent to a method for producing an electrode active material for a secondary battery.

Further, yet another object of the present invention is to provide an electrode active material for a secondary battery, which is produced in accordance with the production method described above, and a secondary battery using the electrode active material for a secondary battery as an electrode material.

The method for producing an electrode active material for a secondary battery in accordance with the present invention provides a method for producing an electrode active material for a secondary battery, which contains a lithium containing phosphate compound with a olivine-type framework represented by LiMPO₄ (wherein, M is one or more elements selected from the group consisting of Mn, Fe, Co, Cu, Ni, and Mg), and the method includes the following steps:

(A) a first firing step of firing a mixed powder of starting raw materials for the electrode active material for a secondary battery at a first temperature;
(B) a grinding step of grinding the powder obtained in the first firing step; and
(C) a second firing step of firing the powder obtained in the grinding step at a second temperature higher than the first temperature.

The first firing step includes a step of heating the mixed powder of the raw materials until a volatile component is removed almost completely.

The method for producing an electrode active material for a secondary battery according to the present invention can substantially complete the removal of the volatile component in the first firing step, thus allowing an increase in the internal pressure in a vessel due to the production of the volatile component to be suppressed in the grinding step of grinding the powder obtained in the first firing step.

In the method for producing an electrode active material for a secondary battery according to the present invention, the first temperature refers to a temperature for the removal of volatile components, which is specifically, 500° C. or more preferably.

In addition, in the method for producing an electrode active material for a secondary battery according to the present invention, the second temperature refers to a temperature for the synthesis of a lithium containing phosphate compound with an olivine-type framework represented by crystalline LiMPO₄ (wherein, M is one or more elements selected from the group consisting of Mn, Fe, Co, Cu, Ni, and Mg), which is specifically, 550° C. to 1000° C. preferably.

Furthermore, the second temperature is preferably a temperature 50° C. or more higher than the first temperature.

In the method for producing an electrode active material for a secondary battery according to the present invention, the starting raw materials preferably includes at least one selected from the group consisting of phosphates, hypophosphites, phosphites, metaphosphates, carbonates, ammonium salts, metal oxides, and metal hydroxides.

In the method for producing an electrode active material for a secondary battery according to the present invention, a firing atmosphere in the first firing step preferably includes 1 volume % or more of oxygen. This content of oxygen can effectively promote the volatilization of carbon, nitrogen, and oxygen contained in the starting raw materials, and the removal of the volatile components can be thus carried out effectively.

In the method for producing an electrode active material for a secondary battery according to the present invention, the grinding step is preferably carried out with the use of a ball mill. This grinding step can enhance the productivity, and thus reduce the production cost.

The method for producing an electrode active material for a secondary battery according to the present invention preferably further includes, between the grinding step and the second firing step, a mixing step of mixing the powder obtained in the grinding step with either a carbon powder or an organic material to be carbonized in the second firing step. This mixing step allows the effect for electron conductivity to be produced sufficiently through the addition of carbon powder to a positive electrode active material, because the volatile component has been substantially removed after the grinding step.

The electrode active material for a secondary battery according to the present invention is produced in accordance with any one of the above-mentioned methods.

The secondary battery according to the present invention uses the above-mentioned electrode active material for an electrode material.

The precursor for an electrode active material for a secondary battery according to the present invention contains a lithium containing phosphate compound composed of Li, M (M is one or more elements selected from the group consisting of Mn, Fe, Co, Cu, Ni, and Mg), and PO₄, or a lithium containing phosphate compound with an olivine-type framework represented by LiMPO₄ (wherein, M is one or more elements selected from the group consisting of Mn, Fe, Co, Cu, Ni and Mg), and contains substantially no volatile component.

The precursor for an electrode active material for a secondary battery according to the present invention contains substantially no volatile component, and thus allows an increase in the internal pressure in a vessel due to the production of the volatile component to be suppressed even when the grinding step is carried out in a subsequent step.

According to the present invention, the increase in the internal pressure in a vessel due to the production of the volatile component can be suppressed in the grinding step, and there is thus no need to provide the grinding vessel with a gas exhaust mechanism such as a leak valve in the case of producing an electrode active material for a secondary battery, which contains an olivine-type lithium containing phosphate compound. In addition, the addition of carbon powder to the electrode active material for a secondary battery, which contains an olivine-type lithium containing phosphate compound for the purpose of compensation for electron conductivity even allows the effect of compensation for electron conductivity to be produced sufficiently without reducing the effect.

### BRIEF DESCRIPTION OF THE DRAWINGS

FIG. 1 is a diagram showing the result of a thermal analysis for a mixed powder obtained as a precondition in a method for producing a lithium containing manganese phosphate compound as an electrode active material for a secondary battery according to the present invention;

FIG. 2 is a diagram showing the result of a thermal analysis for a mixed powder obtained as a precondition in a method for producing a lithium containing iron phosphate compound as an electrode active material for a secondary battery according to the present invention;

FIG. 3 is a diagram illustrating a coin-shaped non-aqueous electrolyte secondary battery produced according to examples of the present invention and comparative examples; and

FIG. 4 is a diagram showing discharge curves of secondary batteries using, for their electrode materials, electrode active materials for secondary batteries according to the examples of the present invention and the comparative examples.

### DETAILED DESCRIPTION OF THE INVENTION

In one embodiment of the method for producing an electrode active material for a secondary battery according to the present invention, a method is provided for producing an electrode active material for a secondary battery, which contains, for example, LiMnPO₄ and LiFePO₄ as lithium containing phosphate compounds with an olivine-type framework represented by LiMPO₄ (wherein, M is one or more elements selected from the group consisting of Mn, Fe, Co, Cu, Ni, and Mg).

In addition, the electrode active material for a secondary battery according to the present invention may have an olivine-type structure or a structure similar to the olivine-type structure, and may have a composition represented by Li₁₊ₓMP_{1+y}O₄ (−0.2<x<0.2, −0.2<y<0.2; preferably, −0.1≦x≦0.1, −0.1≦y≦0.1) in which the ratio between Li and P is not a fixed ratio. Furthermore, the electrode active material for a secondary battery according to the present invention may have some of M substituted with Al, Ti, V, Cr, Zr, Nb, etc., as long as the electrode active material has an olivine-type structure. In addition, some of P may be substituted with B, Si, etc.

In one embodiment of the method for producing an electrode active material for a secondary battery according to the present invention, a mixed powder of starting raw materials for the electrode active material for a secondary battery is first subjected to firing at a first temperature. In this first firing step, the mixed powder of the raw materials is heated until volatile components, for example, a nitrogen compound, an oxygen compound, a carbon compound, a hydrogen compound, etc., are removed almost completely.

The first temperature is preferably a temperature for the removal of the volatile components. In addition, the temperature for the removal of the volatile components, which varies depending on the types of compounds constituting the mixed powder of the starting raw materials, is preferably a temperature higher than 400° C. If the first temperature is a temperature of 400° C. or less, there is a possibility that the volatile components may be removed insufficiently to possibly cause the volatile components to remain. The first temperature is further preferably a temperature of 500° C. or more. It is to be noted that the volatile component, first temperature, and heating time are determined according to the types of the compounds constituting the mixed powder of the starting raw materials.

As the compounds constituting the mixed powder of the starting raw materials, at least one selected from the group consisting of phosphates, hypophosphites, phosphites, metaphosphates, carbonates, ammonium salts, metal oxides, and metal hydroxides can be used. The mixed powder of the starting raw materials is a mixture of a raw material for lithium (a lithium source), a raw material for phosphorus (a phosphorus source), and a raw material for metal element M (an M source).

As the phosphorus source, at least one selected from the group consisting of phosphates, hypophosphites, phosphites, metaphosphates such as pyrophosphate, carbonates, ammonium salts, metal oxides, and metal hydroxides can be used. As the phosphates mentioned above, ammonium phosphate salts, diammonium phosphate salts, hydrogenphosphate salts, and dihydrogenphosphate salts may be used. As the phosphites mentioned above, ammonium phosphites, ammonium hydrogen phosphites, and hydrogenphosphites may be used. As the metaphosphates mentioned above, dimetaphosphates, trimetaphosphates, and the like may be used. As the ammonium salts mentioned above, ammonium phosphate ((NH₄)₃PO₄), diammonium hydrogenphosphate ((NH₄)₂HPO₄), ammonium dihydrogen phosphate (NH₄H₂PO₄), and the like may be used.

As the lithium source, a lithium carbonate, a lithium oxide, a lithium hydroxide, lithium dihydrogen phosphate (LiH₂PO₄), etc. can be used.

As a raw material which serves as the phosphorus source and the lithium source, lithium phosphate (Li₃PO₄), lithium metaphosphate (LiPO₃), lithium dihydrogen phosphate (LiH₂PO₄), LiNH₄HPO₄, or the like can be used.

As the M source, carbonates, ammonium salts, oxides, hydroxides, halides, etc. can be used.

Next, the powder obtained in the first firing step is subjected to grinding. The grinding step carried out with the use of a ball mill can enhance the productivity, and thus reduce the production cost.

Then, in the second firing step, the powder obtained in the grinding step is subjected to firing at a second temperature higher than the first temperature. The second temperature refers to a temperature for providing a lithium containing phosphate compound with an olivine-type framework represented by crystalline LiMPO₄ (wherein, M is one or more elements selected from the group consisting of Mn, Fe, Co, Cu, Ni, and Mg), which is specifically, 550° C. to 1000° C. preferably. Further preferably, the second temperature is 800° C. to 1000° C. The second temperature is more preferably a temperature which is 50° C. or more higher than the first temperature. It is to be noted that the heating temperature and the heating time can be arbitrarily set in consideration of the demand characteristics, productivity, etc. of the secondary battery.

In this way, the method for producing an electrode active material for a secondary battery according to the present invention can substantially complete the removal of volatile components in the first firing step, thus allowing an increase in the internal pressure in a vessel due to the production of volatile components to be suppressed in the grinding step of grinding the powder obtained in the first firing step.

The firing atmosphere in the first firing step preferably contains 1 volume % or more of oxygen. The firing atmosphere containing 1 volume % or more of oxygen can effectively promote the volatilization of carbon, nitrogen, and hydrogen contained in the starting raw materials, and the removal of the volatile components can be thus carried out effectively.

In another embodiment of the method for producing an electrode active material for a secondary battery according to the present invention, a mixing step of mixing the powder obtained in the grinding step with either a carbon powder or an organic material to be carbonized in the second firing step can be carried out between the grinding step and the second firing step. The implementation of this mixing step allows the reaction of the volatile component with carbon powder to be inhibited, because the volatile component has been substantially removed after the grinding step. In particular, the lithium containing phosphate compound with an olivine-type framework is poor in electron conductivity, and produces an insufficient effect of providing electron conductivity in the case of firing simply. However, the present invention allows the effect for electron conductivity to be produced sufficiently through the addition of carbon powder to a positive electrode active material.

In the embodiment of the method for producing an electrode active material for a secondary battery, the powder obtained in the first firing step contains a lithium containing phosphate compound composed of Li, M (M is one or more elements selected from the group consisting of Mn, Fe, Co, Cu, and Mg), and PO₄, or a lithium containing phosphate compound with an olivine-type framework represented by LiMPO₄ (wherein, M is one or more elements selected from the group consisting of Mn, Fe, Co, Cu, and Mg), and contains substantially no volatile component.

The electrode active material for a secondary battery, which is obtained in accordance with the present invention, can be used for an electrode material of either a positive electrode or a negative electrode, and can be combined with non-aqueous electrolyte solutions, solid electrolytes, polymer electrolytes, gel electrolytes, etc, to manufacture secondary batteries. The non-aqueous electrolyte solutions include an ethylene carbonate (EC)-diethyl carbonate (DEC) solution dissolving LiPF₆ therein, the solid electrolytes include sulfide based solid electrolytes such as Li₂S—P₂S₅, perovskite based solid electrolytes such as LIPON and LiLaTiO₃, and NASICON based solid electrolytes such as LATP (LiAlTi(PO₄)), the polymer electrolytes include polyethylene oxide (PEO) containing LiPF₆, and the gel electrolytes include a gel electrolyte of a gelled polymer impregnated with a non-aqueous electrolyte solution.

When the electrode active material for a secondary battery, which is obtained in accordance with the present invention, is used as an electrode material of a positive electrode, carbon materials, oxides such as lithium titanate, lithium metal and alloys, etc., which are generally used in lithium ion batteries, can be used as an electrode material of a negative electrode.

### EXAMPLES

Examples of producing an electrode active material for a secondary battery according to the present invention and comparative examples will be described below.

### Example 1

### Comparative Example 1

In Example 1 and Comparative Example 1 below, lithium containing manganese phosphate compounds (LiMnPO₄) were produced as electrode active materials for secondary batteries.

<Thermal Analysis of Mixed Powder of Raw Materials>

Lithium carbonate (Li₂CO₃), manganese oxide (Mn₃O₄), and ammonium dihydrogenphosphate (NH₄H₂PO₄) were used as starting raw materials. These raw materials were weighed so as to provide molar ratios of 27.3% for LiCO₃, 18.2% for Mn₃O₄, and 54.5% for NH₄H₂PO₄, encapsulated in a 500 mL polyethylene pot, and rotated at a rotation speed of 150 rpm for 6 hours in the pot to obtain a mixed powder of the raw materials.

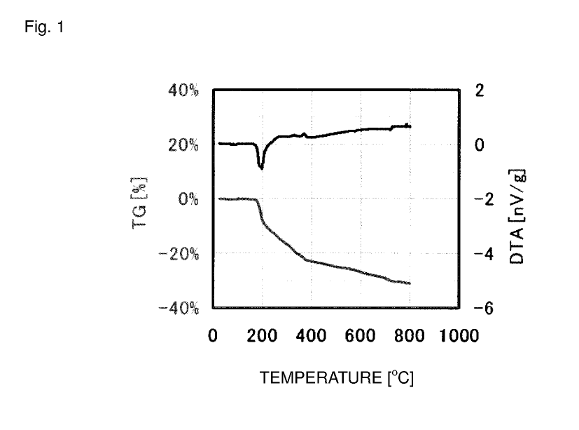

In order to check the temperature for the completion of removal of volatile components, the mixed powder of the raw materials was subjected to a thermal analysis (TG measurement) at a rate of temperature increase of 5° C./minute under an oxygen atmosphere. The result is shown in FIG. 1.

In this case, it is possible to estimate the amounts of volatile components produced in the synthesis of a lithium containing manganese phosphate compound from the reaction formula of the synthesis reaction. For example, as described above, when lithium carbonate, manganese oxide, and ammonium dihydrogenphosphate are used as the starting raw materials, the following chemical reaction is considered.

½Li₂CO₃+⅓Mn₃O₄+NH₄H₂PO₄→LiMnPO₄+[H₂O+CO₂+N₂]

In this case, with the assumption that the volatile components are H₂O, CO₂, and N₂, the volatilization can be estimated to be on the order of 31.1% of the total mass.

It has been determined from the result of thermogravimetry shown in FIG. 1 with respect to the estimated value that the removal of the volatile components is completed, because the mixed powder of the raw materials undergoes a decrease in mass on the order of 30% of the total mass at a temperature of 700° C.

It is to be noted that the value from the actual thermogravimetry is slightly smaller than the estimated value, because the reaction was initiated already during the mixing of the starting raw materials.

<Production of Active Material>

### Example 1

As an electrode active material for a secondary battery according to Example 1, an active material powder A₃ was produced as follows.

The obtained mixed powder of the raw materials was subjected to firing at a temperature of 700° C. for 8 hours under an air atmosphere (first firing step) to obtain a fired powder A₁ (precursor A) with volatile components removed therefrom (containing substantially no volatile components).

The precursor A with water added thereto was encapsulated along with balls of 5 mm in diameter in a 500 mL polyethylene pot, and rotated at a rotation speed of 150 rpm for 24 hours in the pot to grind the precursor A (grinding step). After that, the ground precursor A was dried on a hot plate heated to a temperature of 120° C. to obtain a ground powder A₂.

The ground powder A₂ was subjected to firing at a temperature of 900° C. for 20 hours under a nitrogen atmosphere (second firing step) to obtain an active material powder A₃.

### Comparative Example 1

For comparison, an active material powder B₃ was produced as follows as an electrode active material for a secondary battery according to Comparative Example 1.

The mixed powder of the raw materials was subjected to firing at a temperature of 300° C. for 8 hours under an air atmosphere (a step corresponding to the first firing step) to obtain a fired powder B₁ with volatile components insufficiently removed therefrom.

After that, an active material powder B₃ was produced through a ground powder B₂ in the same way as in Example 1.

<Evaluation>

The active material powder A₃ and the active material powder B₃ were subjected to powder X-ray diffraction (XRD) analysis under the conditions of a scan speed of 1.0°/minute and an angle measuring range of 10° to 60° with the use of an X-ray diffractometer, thereby confirming the produced compounds.

As a result, the X-ray diffraction patterns for the active material powder A₃ and the active material powder B₃ substantially correspond with the pattern of the JCPDS (Joint Committee on Powder Diffraction Standards) card (Card No. 74-0375) for a lithium containing manganese phosphate compound LiMnPO₄ including an olivine-type framework, and it has been thus determined that the active material powder A₃ and the active material powder B₃ are lithium containing manganese phosphate compounds including an olivine-type framework.

In Example 1 and Comparative Example 1, the change in the internal pressure in the pot vessel was determined from the appearance configuration of the pot vessel after the grinding step. While no change of form was observed in the case of the pot vessel in Example 1, it was visually confirmed that both the side and the bottom were expanded to increase the internal pressure significantly in the case of the pot vessel in Comparative Example 1.

From the results described above, it has been confirmed that the use of the precursor A with volatile components removed therefrom, obtained in accordance with Example 1, results in the smaller increase in the internal pressure in the pot vessel in the grinding step.

### Example 2

### Comparative Example 2

In Example 2 and Comparative Example 2 below, lithium containing iron phosphate compounds (LiFePO₄) were produced as electrode active materials for secondary batteries.

<Thermal Analysis of Mixed Powder of Raw Materials>

Lithium carbonate (Li₂CO₃), iron oxide (Fe₂O₃), and ammonium dihydrogenphosphate (NH₄H₂PO₄) were used as starting raw materials. These raw materials were weighed so as to provide molar ratios of 25.0% for LiCO₃, 25.0% for Fe₂O₃, and 50.0% for NH₄H₂PO₄, encapsulated in a 500 mL polyethylene pot, and rotated at a rotation speed of 150 rpm for 6 hours in the pot to obtain a mixed powder of the raw materials.

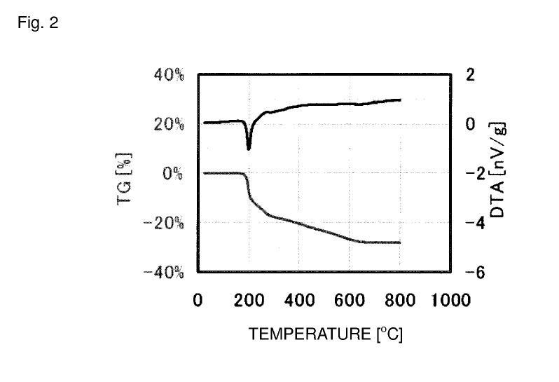

In order to check the temperature for the completion of removal of volatile components, the mixed powder of the raw materials was subjected to a thermal analysis (TG measurement) at a rate of temperature increase of 5° C./minute under an oxygen atmosphere. The result is shown in FIG. 2.

In this case, it is possible to estimate the amounts of volatile components in the synthesis of a lithium containing iron phosphate compound from the reaction formula of the synthesis reaction. For example, as described above, when lithium carbonate, iron oxide, and ammonium dihydrogenphosphate are used as the starting raw materials, the following chemical reaction is considered.

½Li₂CO₃+½Fe₂O₃+NH₄H₂PO₄→LiFePO₄+[H₂O+CO₂+N₂]

In this case, with the assumption that the volatile components are H₂O, CO₂, and N₂, the volatilization can be estimated to be on the order of 31.9% of the total mass.

It has been determined from the result of thermogravimetry shown in FIG. 2 with respect to the estimated value that the removal of the volatile components is completed, because the mixed powder of the raw materials undergoes a decrease in mass on the order of 28% of the total mass at a temperature of 600° C.

It is to be noted that the value from the actual thermogravimetry is slightly smaller than the estimated value, because the reaction was initiated already during the mixing of the starting raw materials.

<Production of Active Material>

### Example 2

As an electrode active material for a secondary battery according to Example 2, an active material powder C₃ was produced as follows.

The obtained mixed powder of the raw materials was subjected to firing at a temperature of 600° C. for 8 hours under an air atmosphere (first firing step) to obtain a fired powder C₁ (precursor C) with volatile components removed therefrom (containing substantially no volatile components). After that, an active material powder C₃ was produced through a ground powder C₂ in the same way as in Example 1.

### Comparative Example 2

For comparison, an active material powder D₃ was produced as follows as an electrode active material for a secondary battery according to Comparative Example 2.

The mixed powder of the raw materials was subjected to firing at a temperature of 300° C. for 8 hours under an air atmosphere (a step corresponding to the first firing step) to obtain a fired powder D₁ with volatile components insufficiently removed therefrom.

After that, an active material powder D₃ was produced through a ground powder D₂ in the same way as in Example 1.

<Evaluation>

The active material powder C₃ and the active material powder D₃ were subjected to powder X-ray diffraction (XRD) analysis under the conditions of a scan speed of 1.0°/minute and an angle measuring range of 10° to 60° with the use of an X-ray diffractometer, thereby confirming the produced compounds.

As a result, the X-ray diffraction patterns for the active material powder C₃ and the active material powder D₃ substantially correspond with the pattern of the JCPDS card (Card No. 83-2092) for a lithium containing iron phosphate compound LiFePO₄ including an olivine-type framework, and it has been thus determined that the active material powder C₃ and the active material powder D₃ are lithium containing iron phosphate compounds including an olivine-type framework.

In Example 2 and Comparative Example 2, the change in the internal pressure in the pot vessel was determined from the appearance configuration of the pot vessel after the grinding step. While no change of form was observed in the case of the pot vessel in Example 2, it was visually confirmed that both the side and the bottom were expanded to increase the internal pressure significantly in the case of the pot vessel in Comparative Example 2.

From the results described above, it has been confirmed that the use of the fired powder C₁ with volatile components removed therefrom, obtained in accordance with Example 2, results in the smaller increase in the internal pressure in the pot vessel in the grinding step.

### Example 3

### Comparative Example 3

In Example 3 and Comparative Example 3, lithium containing manganese phosphate compounds (LiMnPO₄) with carbon added thereto for the compensation for electron conductivity of electrode active material powder were produced as electrode active materials for secondary batteries.

<Production of Active Material>

As electrode active materials for secondary batteries according to Example 3 and Comparative Example 3, an active material powder E₃ and an active material powder F₃ were produced as follows.

Each of the ground powder A₂ produced in Example 1 and the ground powder B₂ produced in Comparative Example 1 and Ketjen Black (from Lion Corporation; model number: ECP600JD) were blended so as to result in 90:10 in terms of ratio by weight, encapsulated in a 500 mL polyethylene pot, and rotated at a rotation speed of 150 rpm for 6 hours in the pot (mixing step) to obtain a mixed powder E₄ and a mixed powder F₄.

The mixed powder E₄ and the mixed powder F₄ were each subjected to firing at a temperature of 900° C. for 20 hours under a nitrogen atmosphere (second firing step) to obtain an active material powder E₃ and an active material powder F₃.

<Evaluation>

The active material powder E₃ and the active material powder F₃ were subjected to powder X-ray diffraction (XRD) analysis under the conditions of a scan speed of 1.0°/minute and an angle measuring range of 10° to 60° with the use of an X-ray diffractometer, thereby confirming the produced compounds.

As a result, the X-ray diffraction patterns for the active material powder E₃ and the active material powder F₃ substantially correspond with the pattern of the JCPDS card (Card No. 74-0375) for a lithium containing manganese phosphate compound LiMnPO₄ including an olivine-type framework, and it has been thus determined that the active material powder E₃ and the active material powder F₃ are lithium containing manganese phosphate compounds including an olivine-type framework.

After that, the active material powder E₃ and the active material powder F₃ were each heated from room temperature to a temperature of 1000° C. at a rate of temperature increase of 5° C./minute to quantitate the amount of carbon contained in each of the active material powder E₃ and the active material powder F₃ with the use of a total organic carbon (TOC) measurement device.

It has been determined from this measurement result that 98% of the carbon added to the active material powder E₃ and 52% of the carbon added to the active material powder F₃ in terms of ratio by weight remain as organic carbon. More specifically, unremoved remaining volatile components reacted with most of the added carbon to reduce the effect of compensation for electron conductivity of a positive electrode active material in the case of the active material powder F₃. On the other hand, almost all of the added carbon produced the effect of compensation for electron conductivity in the case of the active material powder E₃, because of the removal of volatile components.

From this result, it has been determined that it is particularly preferable in the first firing step to remove in advance volatile components which will potentially react with carbon added in a subsequent step, in order to maximize the effect of carbon powder added to an electrode active material for a secondary battery for the purpose of compensation for electron conductivity.

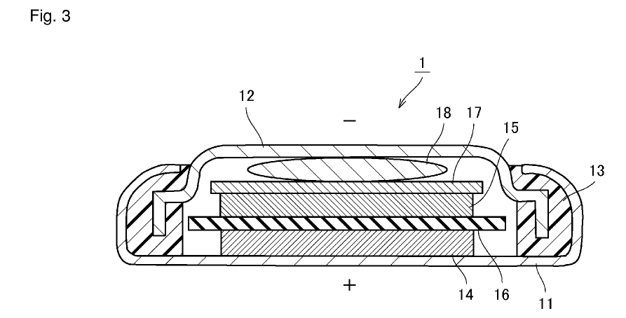

Next, the active material powder E₃ and active material powder F₃ with carbon added thereto were each used to produce coin-shaped non-aqueous electrolyte secondary batteries as shown in FIG. 3.

As shown in FIG. 3, the coin-shaped non-aqueous electrolyte secondary battery 1 is composed of a case 11 which also serves as a positive electrode terminal, a sealing plate 12 which also serves as a negative electrode terminal, a gasket 13 for insulating the case 11 and the sealing plate 12 from each other, a positive electrode 14, a negative electrode 15, a separator 16 interposed between the positive electrode 14 and the negative electrode 15, a current collecting plate 17 placed on the negative electrode 15, and a spring member 18 placed between the current collecting plate 17 and the sealing plate 12, and the inside of the case 11 is filled with an electrolyte solution.

The active material powder E₃ and active material powder F₃ produced as described above were each used for the production of the positive electrode 14 for the coin-shaped non-aqueous electrolyte secondary battery 1 shown in FIG. 3, and the function effects were examined as electrode active materials for non-aqueous electrolyte secondary batteries according to Example 3 and Comparative Example 3.

Specifically, each of the active material powder E₃ and active material powder F₃ with carbon added thereto, a carbon material, and N-methyl-2-pyrrolidone were mixed at a ratio by weight of 7:2:1 to produce each positive electrode composite. This positive electrode composite was applied onto the surface of aluminum foil, subjected to drying, and then pressing at a pressure of 1 ton/cm², and then subjected to punching into a circular plate of 12 mm in diameter, thereby producing an electrode sheet. This electrode sheet was used as the positive electrode 14 of the coin-shaped non-aqueous electrolyte secondary battery 1 shown in FIG. 3. For the negative electrode 15, a circular plate composed of metal lithium foil of 15.5 mm in diameter was used. The current collecting plate 17 was bonded to the negative electrode 15. For the separator 16, a polyethylene porous membrane was used in the shape of a circular plate with a diameter of 16 mm. As the electrolyte solution, 1 mol of LiPF₆ was used which was mixed in a solvent of ethylene carbonate and diethyl carbonate mixed at a volume ratio of 3:7. In this way, the coin-shaped non-aqueous electrolyte secondary battery 1 was produced with a diameter of 20 mm and a thickness of 3.2 mm.

Furthermore, the active material powder A₃ with no carbon added thereto was used to produce the positive electrode 14 for the coin-shaped non-aqueous electrolyte secondary battery 1 shown in FIG. 3, and produce the coin-shaped non-aqueous electrolyte secondary battery 1 in the same way as described above.

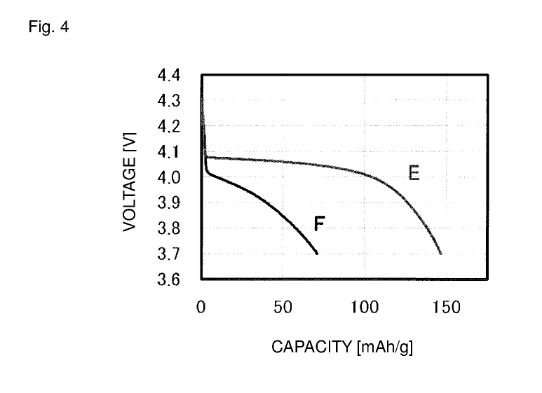

The respective coin-shaped non-aqueous electrolyte secondary batteries 1 produced in the way described above were used to evaluate charge and discharge characteristics. As a result of a constant-current charge and discharge test at a constant current value of 100 μA in the voltage range of 3.7 V to 4.8 V, the coin-shaped non-aqueous electrolyte secondary battery 1 using the active material powder A₃ was not charged or discharged. As shown in FIG. 4, it is determined that the discharge curve (E) for the coin-shaped non-aqueous electrolyte secondary battery 1 using the active material powder E₃ according to Example 3 shows a higher discharged capacity, as compared with the discharge curve (F) for the coin-shaped non-aqueous electrolyte secondary battery 1 using the active material powder F₃ according to Comparative Example 3.

The embodiments and examples disclosed herein should be considered by way of example in all respects and non-restrictive. The scope of the present invention is defined by the claims below, rather than the embodiments and examples described above, and indented to encompass all modifications and changes within the spirit and scope equivalent to the claims.

The method for producing an electrode active material for a secondary battery and the precursor of the electrode active material for a secondary battery according to the present invention can suppress an increase in the internal pressure in a vessel due to volatile components produced in the grinding step. Thus, there is no need to provide the grinding vessel with a gas exhaust mechanism such as a leak valve in the case of producing an electrode active material for a secondary battery, which contains an olivine-type lithium containing phosphate compound, and no problem is caused in a subsequent step. Therefore, an electrode active material can be obtained which is useful for the production of, for example, lithium ion secondary batteries and all-solid-state secondary batteries.

What is claimed is:

1. A method for producing an electrode active material for a secondary battery, which contains a lithium containing phosphate compound with a olivine-type framework represented by LiMPO₄, wherein M is one or more elements selected from the group consisting of Mn, Fe, Co, Cu, Ni, and Mg, the method comprising:
a first firing step of firing a mixture of starting raw materials for the electrode active material at a first temperature to produce a first fired mixture;
grinding the first fired mixture into a ground powder; and
a second firing step of firing the ground powder at a second temperature higher than the first temperature,
wherein the first firing step includes a step of heating the mixture until a volatile component is removed therefrom almost completely.

2. The method for producing an electrode active material for a secondary battery according to claim 1, wherein the first temperature is a temperature for the removal of the volatile component.

3. The method for producing an electrode active material for a secondary battery according to claim 2, wherein the temperature for the removal of the volatile component is 400° C. or more.

4. The method for producing an electrode active material for a secondary battery according to claim 3, wherein the temperature for the removal of the volatile component is 500° C. or more.

5. The method for producing an electrode active material for a secondary battery according to claim 1, wherein the second temperature is a temperature for the synthesis of the lithium containing phosphate compound.

6. The method for producing an electrode active material for a secondary battery according to claim 5, wherein the second temperature is 550° C. to 1000° C.

7. The method for producing an electrode active material for a secondary battery according to claim 6, wherein the second temperature is 800° C. to 1000° C.

8. The method for producing an electrode active material for a secondary battery according to claim 1, wherein the second temperature is a temperature which is 50° C. or more higher than the first temperature.

9. The method for producing an electrode active material for a secondary battery according to claim 1, wherein the starting raw materials comprise at least one material selected from the group consisting of phosphates, hypophosphites, phosphites, metaphosphates, carbonates, ammonium salts, metal oxides, and metal hydroxides.

10. The method for producing an electrode active material for a secondary battery according to claim 9, wherein the starting raw materials are selected from the group consisting of ammonium phosphate salts, diammonium phosphate salts, hydrogenphosphate salts, dihydrogenphosphate salts ammonium phosphites, ammonium hydrogen phosphites, hydrogenphosphites, dimetaphosphates, trimetaphosphates, ammonium phosphate ((NH₄)₃PO₄), diammonium hydrogenphosphate ((NH₄)₂HPO₄), ammonium dihydrogen phosphate (NH₄H₂PO₄), lithium carbonate, lithium oxide, lithium hydroxide, lithium dihydrogen phosphate (LiH₂PO₄), lithium phosphate (Li₃PO₄), lithium metaphosphate (LiPO₃), and lithium dihydrogen phosphate (LiH₂PO₄), LiNH₄HPO₄.

11. The method for producing an electrode active material for a secondary battery according to claim 1, wherein a firing atmosphere in the first firing step comprises 1 volume % or more of oxygen.

12. The method for producing an electrode active material for a secondary battery according to claim 1, wherein the grinding is carried out with the use of a ball mill.

13. The method for producing an electrode active material for a secondary battery according to claim 1, further comprising, between the grinding and the second firing step, mixing the ground powder with one of a carbon powder and an organic material to be carbonized in the second firing step.

14. An electrode active material for a secondary battery, which is produced in accordance with the method according to claim 1.

15. A secondary battery having the electrode active material according to claim 14 as an electrode material.

16. A precursor containing a lithium containing phosphate compound composed of Li, M, and PO₄, and containing substantially no volatile component, wherein M is one or more elements selected from the group consisting of Mn, Fe, Co, Cu, Ni and Mg.

17. A precursor containing a lithium containing phosphate compound with an olivine-type framework represented by LiMPO₄, and containing substantially no volatile component, wherein M is one or more elements selected from the group consisting of Mn, Fe, Co, Cu, Ni and Mg.
